(19) United States
(12) Patent Application Publication
(10) Pub. No.: US 2025/0301382 A1
(43) Pub. Date: Sep. 25, 2025

(54) TERMINAL AND RADIO COMMUNICATION METHOD

(71) Applicant: NTT DOCOMO, INC., Tokyo (JP)

(72) Inventor: Tianyang MIN, Tokyo (JP)

(73) Assignee: NTT DOCOMO, INC., Tokyo (JP)

(21) Appl. No.: 19/105,064

(22) PCT Filed: Aug. 18, 2023
(86) PCT No.: PCT/JP2023/029856

§ 371 Date: Feb. 20, 2025

(30) Foreign Application Priority Data
Aug. 22, 2022 (JP) 2022-131517

(51) Int. Cl. H04W 36/08; H04W 36/00

(52) U.S. Cl. CPC H04W 36/08; H04W 36/0058

(57) ABSTRACT

The terminal executes mobility control of at least one of Layer 1 and Layer 2. The terminal transmits a layer 3 measurement report when the mobility control is applied. Specifically, the terminal transmits the measurement report including identification information of at least one of a serving cell and a neighboring cell.

### TECHNICAL FIELD

This disclosure relates to terminal and Radio communication method.

### BACKGROUND ART

The 3rd Generation Partnership Project (3GPP) has specified the 5th generation mobile communication system (5G, also known as New Radio (NR) or Next Generation (NG)) and is in the process of specifying the next generation called Beyond 5G, 5G Evolution or 6G.

For example, 3GPP Release 18 will extend the mobility of terminals (User Equipment, UE) (Non-Patent Literature 1). Specifically, the mobility control at Layer 1 and/or Layer 2 (which may be called L1/L2 Mobility) is considered to achieve lower latency, lower overhead and shorter downtime than the existing mobility at Layer 3.

In addition, security issues related to L1/L2 Mobility are also considered in 3GPP.

### CITATION LIST

### Non-Patent Literature

[Non-Patent Literature 1] “Revised WID on Further NR mobility enhancements,” RP-221558, 3GPP TSG RAN Meeting #96, 3GPP, June 2022

### SUMMARY OF INVENTION

However, when L1/L2 Mobility is realized, the following issues are considered. For example, when a radio base station (gNB) includes a central unit (CU) and a distributed unit (DU), and a UE performs handover (transition) between a plurality of DUs (cells) connected to the same CU, the medium access control layer (MAC) and/or the radio link control layer (RLC) cannot be reset, and the handover may fail.

In addition, when L1/L2 Mobility is applied, identification information (cell ID, etc.) of a cell to which a UE is connected (or camping) or a candidate cell of a transition destination cannot be hidden, and sufficient user security may not be ensured.

Therefore, the following disclosure has been made in view of such a situation, and is intended to provide a terminal and a radio communication method capable of realizing L1/L2 Mobility while ensuring sufficient user security.

One aspect of the present disclosure is a terminal (UE200) including a control unit (control unit 240) that executes mobility control of at least one of Layer 1 and Layer 2, and a transmission unit (measurement reporting unit 220) that transmits a layer 3 measurement report when the mobility control is applied. The transmission unit transmits the measurement report including identification information of at least one of a serving cell and a neighboring cell.

One aspect of the present disclosure is a terminal including a control unit (control unit 240) that executes mobility control of at least one of Layer 1 and Layer 2, and a reception unit (handover execution unit 230) that receives, when the mobility control is applied, at least one of commands of the layer 1 and/or layer 2 including identification information of a provisional serving cell, a synchronization signal block or channel state information.

### BRIEF DESCRIPTION OF DRAWINGS

FIG. 1 is the overall schematic configuration of a radio communication system 10.

FIG. 2 is an example of an inter-DU inter-cell handover configuration.

FIG. 3 is an example of an intra-DU inter-cell handover configuration.

FIG. 4 is a functional block configuration of a gNB100.

FIG. 5 is a functional block configuration of a UE200.

FIG. 6 is an example of operation from a user plane perspective when Intra-DU L1/L2 Mobility or Inter-DU L1/L2 Mobility is applied.

FIG. 7 is a configuration example (dual-connectivity connection) of the cell and the radio link control layer when the L1/L2 Mobility procedure is executed.

FIG. 8 is a configuration example of the radio link control layer and the packet data convergence protocol layer (user plane) when dual connectivity is applied.

FIG. 9 is an example of a sequence according to the L1/L2 Mobility procedure.

FIG. 10 is a diagram showing a provisional cell index configuration example (part 1).

FIG. 11 is a diagram showing a provisional cell index configuration example (part 2).

FIG. 12 is a diagram showing configuration example of the condReconfigId.

FIG. 13 is a diagram showing an example of hardware configuration of the gNB100 and the UE200.

FIG. 14 is a diagram showing configuration example of a vehicle 2001.

### DESCRIPTION OF EMBODIMENT

Exemplary embodiments of the present invention are explained below with reference to the accompanying drawings. Note that, the same or similar reference numerals have been attached to the same functions and configurations, and the description thereof is appropriately omitted.

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

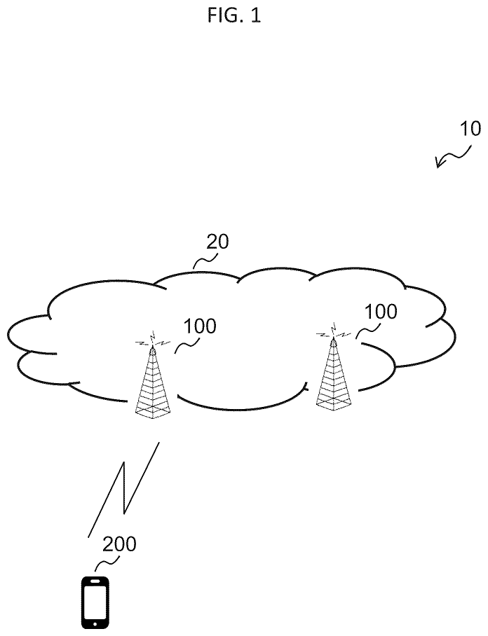

FIG. 1 is an overall schematic configuration diagram of the radio communication system 10 according to this embodiment. The radio communication system 10 is a radio communication system according to the 5G New Radio (NR) and includes the Next Generation-Radio Access Network 20 (hereinafter referred to as NG-RAN20 and terminal 200 (User Equipment 200 (UE 200)).

The radio communication system 10 may include a radio communication system according to the system called Beyond 5G, 5G Evolution or 6G, or a radio communication system according to the system called Long Term Evolution (LTE) or 4G. The radio communication system 10 may support functions related to Industrial Internet of Things (IIoT) and URLLC (Ultra-Reliable and Low Latency Communications).

The NG-RAN20 includes a radio base station 100 (gNB100). The specific configuration of the radio communication system 10 including the number of gNBs (eNBs, etc.) and UEs is not limited to the example shown in FIG. 1.

The gNB100 may also adopt a front-haul (FH) interface specified by the Open Radio Access Network Alliance (O-RAN). The gNB100 may include an O-RU (O-RAN Distributed Unit) and an O-RU (O-RAN Radio Unit). The gNB100 may function as a kind of NG-RAN node.

The NG-RAN20 actually includes a plurality of NG-RAN nodes, specifically gNB (or ng-eNB), which are connected to the core network (5GC, not shown) according to 5G. The 5GC may introduce the concept of CUPS (Control and User Plane Separation), in which the user plane and control plane functions are clearly separated.

An access and mobility management function (AMF), which is included in the system architecture of 5G and provides access and mobility management functions of the UE200, and a session management function (SMF), which provides session management functions, are connected to the NG-RAN20. A UDM/UDR (Unified Data Management/User Data Repository) may be connected to the AMF and/or SMF. The NG-RAN20 and the 5 GC may be simply described as a network.

The gNB100 is a radio base station in accordance with NR, and performs radio communication with the UE200 in accordance with NR. The gNB100 may consist of a CU (Central Unit) and a DU (Distributed Unit), and the DU may be separated from the CU and installed at different geographical locations. The gNB100 (gNB-CU) may be connected by an Xn interface.

The gNB100 and the UE200 can support Massive MIMO, which generates a beam with higher directivity by controlling radio signals transmitted from a plurality of antenna elements, Carrier Aggregation (CA), which bundles a plurality of component carriers (CCs), and Dual Connectivity (DC), which simultaneously communicates between the UE and a plurality of NG-RAN Nodes.

In addition, in the radio communication system 10, mobility control at Layer 1 and/or Layer 2 (L1/L2 Mobility) as well as mobility control of UE200 at Layer 3 (L3 Mobility) may be applied. The L3 Mobility may be interpreted as mobility control at the Radio Resource Control Layer (RRC). On the other hand, the L1/L2 Mobility may be interpreted as mobility control at the Physical Layer (PHY), Media Access Control Layer (MAC), Wireless Link Control Layer (RLC), and Packet Data Convergence Protocol Layer (PDCP).

The Layer 1 may be interpreted as including a lower layer such as PHY. The Layer 3 is a higher layer than the Layer 1. The higher layer may include RRC, and at least one of MAC, RLC, and PDCP.

Mobility of the UE200 may mean movement easiness and maneuverability of the UE200 in a broad sense, but in this embodiment, it may mean transitions between cells. The transitions between cells may include handover and cell selection (including cell reselection). Mobility of the UE200 may mean minimization of call drop, radio link (including beam) failure, unnecessary handover, and ping-pong conditions. The L1/L2 Mobility, which is a lower layer than the L3 Mobility, can realize lower delay, smaller overhead, and shorter downtime than the L3 Mobility.

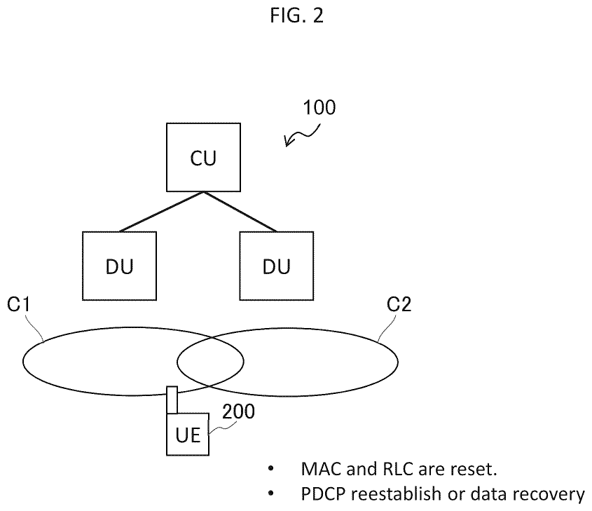

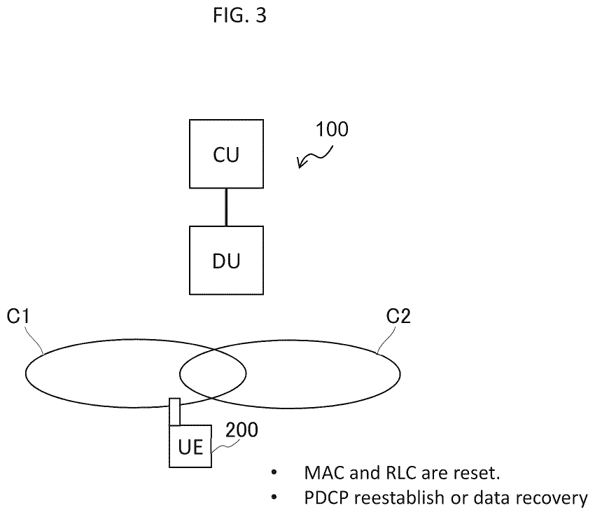

FIG. 2 is an example of an inter-DU inter-cell handover configuration. FIG. 3 is an example of an intra-DU inter-cell handover configuration.

As described above, the gNB100 can adopt a CU-DU configuration. As shown in FIG. 2, multiple DUs may be connected to one CU, or as shown in FIG. 3, one DU may be connected to one CU. The DU may form one or more cells, specifically cell C1 and cell C2.

For example, as shown in FIG. 2, one DU may form cell C1 and the other DU may form cell C2. Alternatively, as shown in FIG. 3, one DU may form cell C1 and cell C2.

An inter-cell handover as shown in FIG. 2 may be referred to as an inter-DU inter-cell handover. An inter-cell handover as shown in FIG. 3 may be referred to as an intra-DU inter-cell handover.

In the case of L3 Mobility, when such a handover is performed, the MAC and RLC may be reset and PDCP reconfiguration or data recovery may be performed. In the case of the L1/L2 Mobility, the MAC and/or RLC may not necessarily be reset (some may be reset).

### (2) Function Block Configuration of Radio Communication System

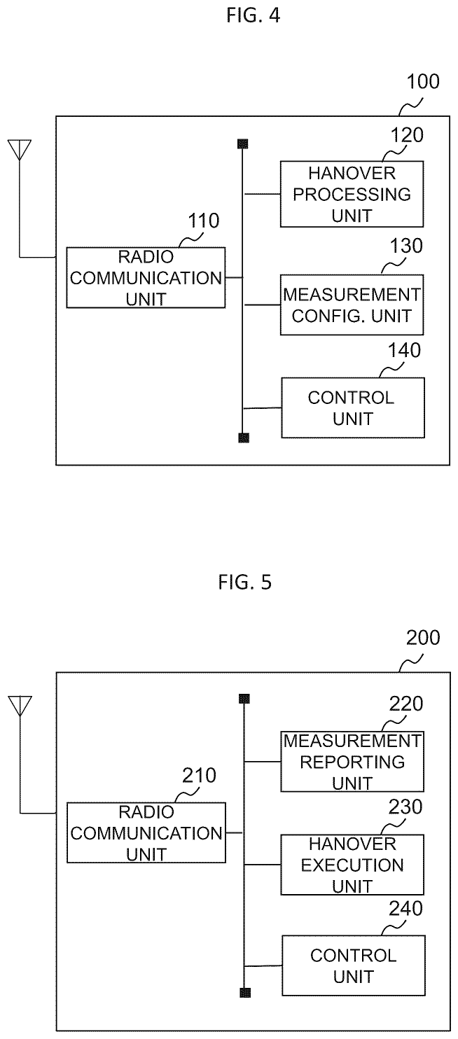

Next, the functional block configuration of the radio communication system 10 will be described. Specifically, the functional block configurations of the gNB100 and the UE200 will be described. FIG. 4 is a functional block configuration diagram of the gNB100. FIG. 5 is a functional block configuration diagram of the UE200.

### (2.1) gNB100

As shown in FIG. 4, the gNB100 includes a radio communication unit 110, a handover processing unit 120, a measurement configuration unit 130, and a control unit 140.

The radio communication unit 110 transmits a downlink signal (DL signal) according to NR. The radio communication unit 110 receives an uplink signal (UL signal) according to NR.

In this embodiment, the radio communication unit 110 may constitute a communication unit that executes communication with a terminal via a radio communication device connected to the same base station device. Specifically, the radio communication unit 110 can execute communication with the UE200 via a DU connected to the same CU.

The CU may be called a central device, an aggregation device, etc., and the DU may be called a distribution device, an extension device, etc.

The handover processing unit 120 executes handover of the UE200. Specifically, the handover processing unit 120 executes handover from the serving cell of the UE200 to other neighboring cells.

It should be noted that the serving cell may be simply interpreted as a cell to which the UE200 is connected. More specifically, in the case of an RRC CONNECTED UE without carrier aggregation (CA), only one serving cell constitutes the primary cell. In the case of an RRC_CONNECTED UE configured with CA, the serving cell may be interpreted as representing a set of one or more cells including the primary cell and all secondary cells.

The handover may also include conditional handover (CHO). The CHO may perform a UE200 driven handover when a specific execution condition is met. If the CHO is not applicable, a normal handover may be performed (also called CHO recovery). In CHO recovery, the UE200 performs cell selection after CHO failure, but if a CHO candidate cell is selected, the conditional RRCReconfiguration of that cell can be applied and reconnected directly without transmitting an RRCRestablementRequest to the candidate target cell.

The execution condition may consist of 1 or 2 trigger conditions (CHO events A3/A5 as specified in 3GPP TS 38.331). A single reference signal (RS) type may be triggered, and up to 2 different trigger quantities (For example, Reference Signal Received Power (RSRP) and Reference Signal Received Quality (RSRQ), RSRP and Signal-to-Interference plus Noise power Ratio (SINR).) may be configured simultaneously to evaluate the CHO execution condition of a single candidate cell.

The measurement configuration unit 130 executes configuration (measurement configuration) of the quality measurement of the serving cell and neighboring cell by the UE200. Specifically, the measurement configuration unit 130 may execute measurement configuration at layer 3, or may execute measurement configuration at layer 1 and/or layer 2.

The measurement configuration unit 130 can notify the UE200 of the content of the measurement configuration. The UE200 may measure the quality of the serving cell and/or neighboring cell based on the notified measurement configuration. The measurement configuration unit 130 can receive a measurement report indicating the measurement result of the cell quality from the UE200. In this embodiment, the measurement configuration unit 130 constitutes a reception unit that receives the measurement report.

The control unit 140 controls each functional block constituting the gNB100. In particular, in this embodiment, the control unit 140 can execute mobility control of the UE200.

Specifically, the control unit 140 may execute L3 mobility control and/or L1/L2 mobility control. For example, with regard to L1/L2 mobility, when the UE200 transitions from a first cell (For example, cell C1) to a second cell (For example, cell C2) formed by a DU (Radio communication device), the control unit 140 may establish a state in which both the first cell and the second cell are connected to the terminal by using the function of Layer 1 (and/or Layer 2).

Here, the state in which both the first cell and the second cell are connected to the terminal may mean dual connectivity (DC) or carrier aggregation (CA).

More specifically, the control unit 140 may execute DC-based L1/L2 mobility in the case of Intra-CU inter-DU HO. Also, the control unit 140 may execute CA-based L1/L2 mobility in the case of Intra-CU intra-DU HO. The control unit 140 may determine handover (HO) after receiving the measurement report of layer 1 from the UE200.

The type of DC may be Multi-RAT Dual Connectivity (MR-DC), which utilizes multiple radio access technologies, or NR-NR Dual Connectivity (NR-DC), which utilizes only NR. The MR-DC may be E-UTRA-NR Dual Connectivity (EN-DC), in which the eNB constitutes the master node (MN) and the gNB constitutes the secondary node (SN), or NR-E-UTRA Dual Connectivity (NE-DC), which is the opposite.

In the DC, a master cell group (MCG) and a secondary cell group (SCG) may be set. The MCG may include a primary cell (PCell), and the SCG may include a secondary cell (SCell).

The control unit 140 may put the SCG in the active state, switch between the PCell and the PSCell, and release the SCG after completion of HO, or put it in the deactivated state. In addition, the control unit 140 may start PDCP duplication for simultaneously operating two PDCPs at HO.

The SCell may also include a primary secondary cell (PSCell). The PSCell is a type of SCell, but may be interpreted as a special SCell with the same functions as the PCell. Like the PCell, the PSCell may perform the following functions: transmission of PUCCH (Physical Uplink Control Channel), contention type random access procedure (CBRA), radio link monitoring, etc.

The RA procedure may be simply read as random access channel (RACH). The RA procedure (RACH) may include two-step RACH and four-step RACH.

The RA procedure (RACH) may include two-step RACH and four-step RACH. In the two-step RACH, messages (MSG) A, B (Random Access Preamble, Contention Resolution/Random Access Response) may be transmitted and received. In the 4 step RACH, MSG1˜4 (Random Access Preamble, Random Access Response, Scheduled Transmission, Contention Resolution) may be transmitted and received.

In this embodiment, the channel includes a control channel and a data channel. The control channel includes PDCCH (Physical Downlink Control Channel), PUCCH (Physical Uplink Control Channel), PRACH (Physical Random Access Channel), PBCH (Physical Broadcast Channel), and the like.

The data channel includes PDSCH (Physical Downlink Shared Channel), PUSCH (Physical Uplink Shared Channel), and the like.

The reference signal includes a demonstration reference signal (DMRS), a sounding reference signal (SRS), a phase tracking reference signal (PTRS), and a channel state information-reference signal (CSI-RS), and the signal includes a channel and a reference signal. The data may mean data transmitted through the data channel.

In addition, the control unit 140 may cause the PDCP of the CU (base station equipment) side to transmit unacknowledged data (un-Acked data) in the RLC (first radio link control layer) on the first cell side of the DU, and the PDCP of the CU may cause the RLC (second radio link control layer) on the second cell side of the DU to transmit the data. The un-Acked data may be interpreted as data for which the gNB100 has not received an acknowledgement. The data may be replaced by a packet or a protocol data unit (PDU).

Furthermore, the RLC (first radio link control layer) on the first cell side of the DU may reset the first radio link control layer and then retransmit the data to the RLC (second radio link control layer) on the second cell side of the DU. Alternatively, the data may be retransmitted to the second radio link control layer without resetting the first radio link control layer, and after retransmitting the data, the first radio link control layer may be reset. Note that there may be a time when both the RLC on the first cell side of the DU and the RLC on the second cell side of the DU are transiently configured.

### (2.2) UE200

As shown in FIG. 5, the UE200 includes a radio communication unit 210, a measurement reporting unit 220, a handover execution unit 230, and a control unit 240.

The radio communication unit 210 transmits an uplink signal (UL signal) in accordance with NR. The radio communication unit 210 also receives an uplink signal (DL signal) in accordance with NR.

The measurement reporting unit 220 can measure the quality of the serving cell of the UE200 and neighboring cell (neighbor cell) of the serving cell, and report the measurement result (Measurement Report) to the network. The measurement reporting unit 220 may execute the measurement report of the source cell and the target cell in handover. In this embodiment, the measurement reporting unit 220 constitutes transmission unit that transmits the measurement report.

In particular, the measurement reporting unit 220 may transmit the layer 3 measurement report when L1/L2 Mobility, that is, at least one of Layer 1 and Layer 2 mobility control is applied. The layer 3 measurement report may be transmitted to the network before the layer 1 (or Layer 2) measurement report.

The measurement reporting unit 220 may also transmit a layer 3 measurement report including identification information of at least one of the serving cells and neighboring cell. The serving cell may include a secondary cell, and neighboring cell may include a transition destination candidate cell.

The quality of the measurement object may be, for example, the quality included in the Measurement Report specified in 3GPP TS38.331 (For example, Reference Signal Received Power (RSRP), Reference Signal Received Quality (RSRQ)).

The measurement reporting unit 220 may execute not only the measurement in layer 3, but also the measurement in layer 1 (and/or layer 2) of the serving cell and neighboring cell. The measurement in layer 1 and/or layer 2 may be interpreted as the measurement using at least one of PHY, MAC, RLC, and PDCP layer functions and the report of the measurement result, as in L1/L2 Mobility.

The handover execution unit 230 executes the handover of the UE200. Specifically, the handover execution unit 230 may execute handover to the transition destination cell (NG-RAN node) based on the control by the gNB100.

Furthermore, the handover execution unit 230 can execute processes related to normal handover (legacy handover) and conditional handover (CHO).

In the case of CHO, the handover execution unit 230 may transition to the candidate cell when the execution condition is satisfied. As described above, the execution condition may be determined based on the quality of the reference signal (RS), specifically, the value of RSRP, RSRQ, or SINR.

In addition, the transition destination of CHO may not be accompanied by SCG or may be accompanied by SCG. In other words, the transition destination cell of CHO may be a single cell or may consist of a plurality of cells (which may be read as a cell group) according to DC.

Further, when mobility control according to L1/L2 Mobility is applied, the handover execution unit 230 can receive at least one of the commands of the layer 1 and/or the layer including provisional identification information of serving cells, synchronization signal blocks, or channel state information. In this embodiment, the handover execution unit 230 may constitute a reception unit that receives at least one of the commands of the layer 1 and/or the layer including provisional identification information.

The type of the command is not particularly limited, but may be, for example, an L1/L2 Mobility command. The L1/L2 Mobility command may be replaced with another command of the RRC layer.

The control unit 240 controls each functional block constituting the UE200. Specifically, the control unit 240 can control the registration of the UE200 to the network (camping on a specific cell), the measurement report, and the handover of the UE200.

The control unit 240 controls the measurement of cells including serving cells. Specifically, the control unit 240 can control the measurements in Layer 1 (and/or Layer 2) of the serving cell and neighboring cell. That is, the control unit 240 can perform measurements (which may be called L1 measurement) of the serving cell and neighboring cell using the functions of Layer 1 (and/or Layer 2).

When a failure occurs in Layer 1 (and/or Layer 2), the control unit 240 may notify the RRC of its own station of the failure information. The failure information may be notified to a layer other than the RRC (e. g. MAC, RLC, PDCP). The failure information is not particularly limited, but may include identification information (ID) of the source cell (handover source), identification information (ID) of the target cell (handover destination), and/or the quality of the cell (or beam).

Furthermore, the control unit 240 can execute L1/L2 Mobility, that is, mobility control of at least one of Layer 1 and Layer 2. Mobility control by L1/L2 Mobility may include quality measurement of the service area and neighboring cell in Layer 1 or Layer 2, setting of fiber destination candidate cells, cell reselection (transition), handover, and the like.

### (3) Operation of radio communication system

Next, the operation of the radio communication system 10 will be described. Specifically, the operation related to the mobility control (L1/L2 Mobility) at Layer 1 and/or Layer 2 will be described.

### (3.1) Operation Example 1

### (3.1.1) Issue

In intra-CU inter-cell handover (intra-DU inter-cell handover (HO) or inter-DU inter-cell handover (HO)) according to the conventional L3 Mobility, MAC and RLC are reset, and PDCP re-establishment or PDCP data recovery is performed for PDCP. PDCP data recovery may be interpreted as that the transmitting PDCP retransmits PDCP data PDUs that were previously transmitted to the re-established or released AM (Acknowledged Mode) RLC entity and have not been confirmed to be successfully delivered by the lower layer, in ascending order of the associated COUNT value.

In the case of L1/L2 Mobility, in the intra-DU/inter-DU inter-cell HO, MAC and RLC are not reset, or some of them are reset, and normal handover may not be possible.

In particular, when a part of the layer is reset, it becomes a problem which part to reset.

### (3.1.2) Solution

The following is an example of a solution from a user plane (U-plane) perspective to solve the above problems.

### (3.1.2.1) Intra-DU L1/L2 Mobility or Inter-DU L1/L2 Mobility

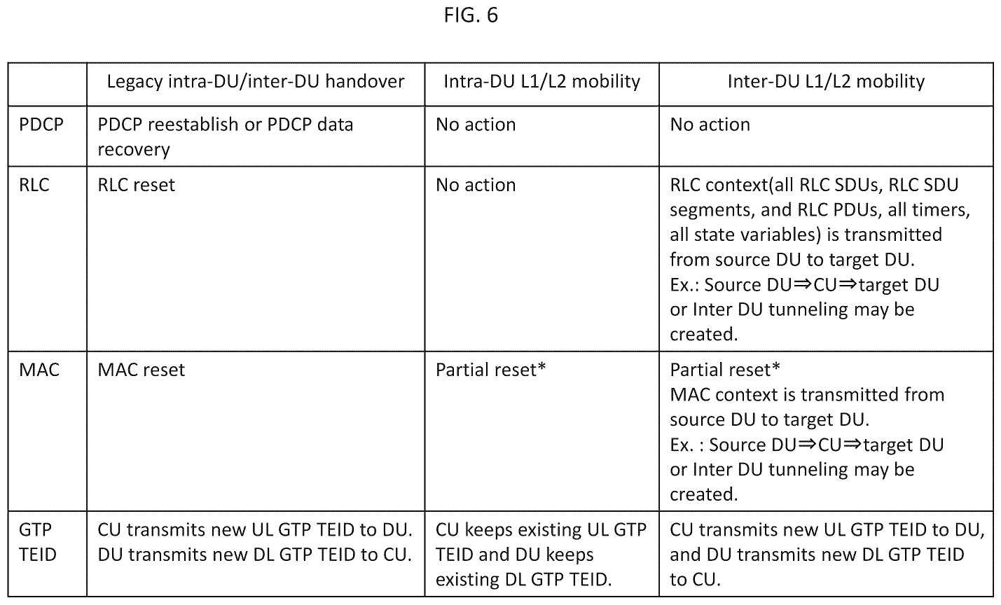

FIG. 6 shows an example of operation from a user plane perspective when Intra-DU L1/L2 Mobility or Inter-DU L1/L2 Mobility is applied.

As shown in FIG. 6, some functions (procedures) of the MAC may be reset in Intra-DU L1/L2 Mobility or Inter-DU L1/L2 Mobility. In addition to the MAC, some functions (procedures) of the RLC may be reset.

When some functions (procedures) of the MAC are reset, for example, among the following functions (procedures) of the MAC, functions (procedures) other than those enclosed in [ ] may be reset.
[initialize Bj for each logical channel to zero;]
stop (if running) all timers;
consider all timeAlignmentTimers as expired and perform the corresponding actions in clause 5.2;
[set the NDIs for all uplink HARQ processes to the value 0]
stop, if any, ongoing RACH procedure;
discard explicitly signalled contention-free Random Access Resources, if any
[flush Msg3 buffer;]
cancel, if any, triggered Scheduling Request procedure;
cancel, if any, triggered Buffer Status Reporting procedure;
cancel, if any, triggered Power Headroom Reporting procedure;
[flush the soft buffers for all DL HARQ processes;]
[for each DL HARQ process, consider the next received transmission for a TB as the very first transmission;]
release, if any, Temporary C-RNTI;
reset BFI COUNTER.

Functions (procedures) enclosed in [ ] may be interpreted as functions (procedures) of the U-plane system, and functions (procedures) not enclosed in [ ] may be interpreted as functions (procedures) of the control plane (C-plane) system. In other words, functions (procedures) of the C-plane system may be reset.

### (3.1.2.2) Intra-CU inter-DU HO or Intra-CU intra-DU HO

In the case of Intra-CU inter-DU HO (see FIG. 2), DC based L1/L2 Mobility may be performed. In the case of Intra-CU intra-DU HO (see FIG. 3), CA based L1/L2 Mobility may be performed.

Specifically, a DC state may be established between the source DU and the candidate target DU. The candidate target DU may be interpreted as a DU (cell) that can be a candidate for a handover destination.

In the case of Intra-DU HO, the candidate target cell may be added as an SCell in the DU. Alternatively, the configuration of the candidate target cell may be preset in the UE without establishing a DC state. The configuration may be indicated to the UE by a message such as MAC or RRC, or may be preset in the UE.

In addition, the SCG and/or SCell may be deactivated for power saving and effective resource utilization. The deactivated state may be interpreted as a state in which the settings of the cell (or cell group) are released, or a state in which not all settings are released but some settings are maintained.

The SCG may be configured to the DRX (Discontinuous Reception) state, or may not be configured to the deactivated or DRX state.

The source DU may decide the HO after receiving the quality measurement result (L1 measurement report) from the UE. Specifically, L1/L2 Mobility (HO) may be executed by any of the following:
After UE receives L1L2 mobility command from gNB
UE does not receive HO instruction from gNB and satisfies predetermined execution condition (event X)

L1/L2 Mobility (HO) may be executed at the same time as receiving L1L2 mobility command or satisfying event X, or within a predetermined time after receiving L1L2 mobility command or satisfying event X.

The predetermined execution condition (event X) may be any of the following, for example:
The quality of the target cell is better than that of the source cell by the offset
The quality of the target cell is better than a predetermined threshold
The quality of the source cell is worse than a predetermined threshold and the quality of the target cell is better than a predetermined threshold

In the case of DC based L1/L2 Mobility, the SCG may be activated and the PCell and PSCell may be switched during HO. In the case of CA based L1/L2 Mobility, at HO, the cell may be activated, and PCell and SCell may be switched, or PSCell and SCell may be switched.

In this case, PDCP duplication may be activated at HO. In addition, the RLC of the source DU may transfer the unAck data to the PDCP of the CU side, and the PDCP of the CU side may transfer the data to the RLC of the target DU. Specifically, the source RLC may retransmit the unAck data after being reset, or the source RLC may transfer the unAck data to the target RLC before being reset without immediately resetting.

Here, the RLC of the source DU and the RLC of the target DU may transiently be in the state of duplication (both active). The RLC of the source DU may reset after receiving a transmission completion instruction from the CU to the target RLC.

In addition, the CU may refer to the highest delivered/highest transmitted sequence number based on the DDDS (Downlink Data Delivery Status) feedback from the source DU to determine which PDU has not been successfully delivered to the UE. The CU may retransmit PDUs not successfully delivered by the source DU to the target DU. After HO completion, the SCG may be released or deactivated.

The UE may hold the configuration of the candidate target cell without resetting after completion of L1/L2 Mobility, or hold the configuration of the source cell without resetting.

Thus, if the quality of the target cell is poor immediately after handover to the target cell, the UE may immediately handover to the source cell or another candidate target cell. The UE may release the configuration after receiving an instruction to release the configuration of the candidate target cell or the source cell via Layer 1 and/or Layer 2 signaling from the network or RRC message.

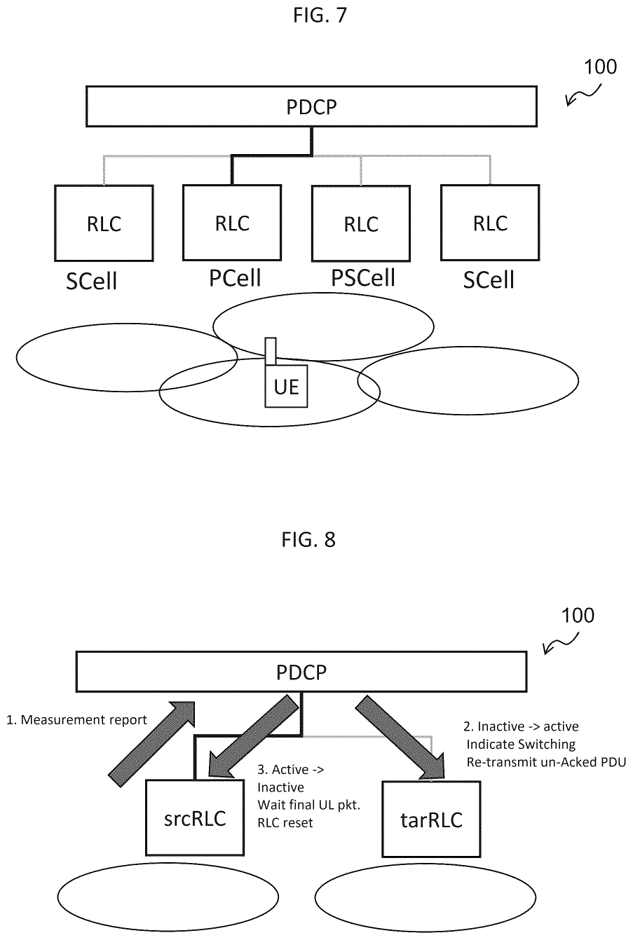

FIG. 7 shows an example of the configuration (dual connectivity connection) of the cell and radio link control layer when the L1/L2 Mobility procedure is executed. As shown in FIG. 7, in the gNB100, an RLC for each cell is configured, and the RLC for the PCcell may be activated. The UE may perform HO to the PSCell or SCell. The PCell and PSCell and the PSCell and SCell may be switched as described above.

FIG. 8 is an example of the configuration of the radio link control layer and the packet data convergence protocol layer (user plane) when dual connectivity is applied. As shown in FIG. 8, the PDCP of gNB100 may receive measurement reports from the UE via the source RLC. The PDCP may retransmit unAck data via the target RLC.

### (3.2) Operation Example 2

As described above, security issues related to L1/L2 Mobility are also considered in 3GPP.

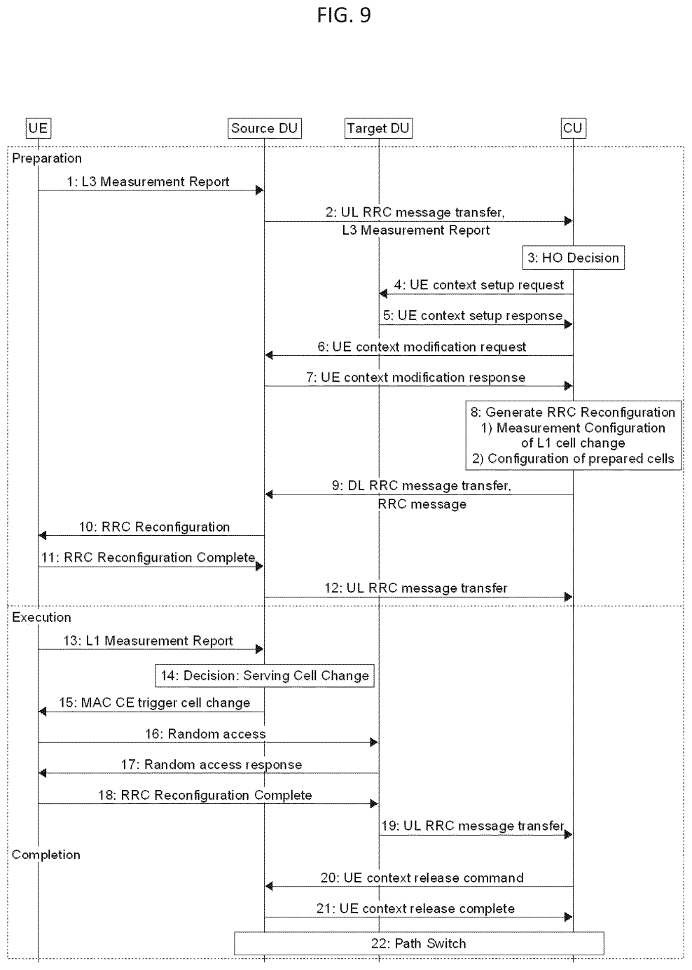

FIG. 9 shows an example of the sequence according to the procedure for L1/L2 Mobility. As shown in FIG. 9, for example, the gNB100 (CU, DU) and the UE200 can execute the Layer 1 measurement report and transmit/receive the MAC CE (control element) of the cell change in the execution phase.

### (3.2.1) Issue

Since the conventional measurement report is transmitted from the UE to the network by the Signalling Radio Bearer 1 (SRB1)/SRB3, there is no security problem such as unconcealed disclosure of the measurement report content (e.g., neighboring cell physical cell ID (PCI)). This is because SRB1/SRB3 have encryption and integrity protection.

The SRB1 and SRB3 can be interpreted as the following radio bearers.
SRB1: This is a radio bearer for RRC messages (which may include piggybacked NAS messages) and NAS messages before the establishment of SRB2, and uses a dedicated control channel (DCCH) logic channel.
SRB3: UE200 is a radio bearer for a specific RRC message in the MR-DC state and uses a DCCH logical channel.

Regarding the security of such cell identification information, the following issues are considered when L1/L2 Mobility is applied.
(Issue 1): There is a security problem if Cell ID (For example, PCI) is included when neighboring cell quality is reported by L1L2 signaling.
(Issue 2): There is a security problem when transmitting a handover command (HO command) from the network to the UE by L1L2 signaling because PCI information of the target cell is included (L1L2 signaling (PUCCH, MAC CE) is not ciphered/integrity protected).

Here, the security problem means, for example, that if PCI information is hacked, the handover history, movement history, and location information of the UE may be identified, and therefore there is a risk that the privacy of the user may be compromised.

### (3.2.2) Solution

To solve the above issues 1 and 2, the UE and the network may operate as follows.

### (3.2.2.1) Solution 1

This solution can solve the issue 1 (L1 measurement reporting security issue). In the L1L2 mobility procedure shown in FIG. 9, the UE first transmits an L3 measurement report to a RAN node such as gNB.

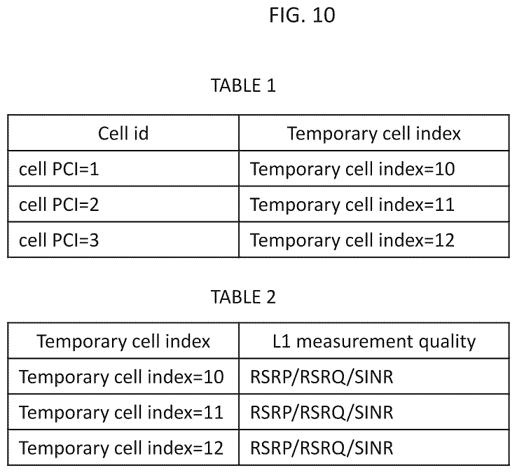

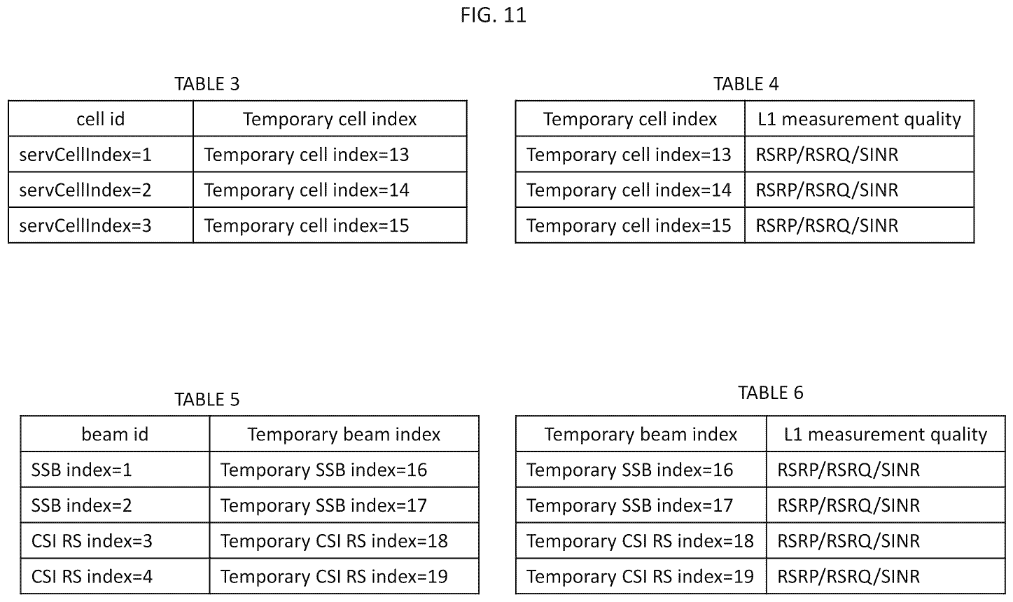

FIG. 10 shows a provisional cell index configuration example (part 1). FIG. 11 shows a provisional cell index configuration example (part 2).

The L3 measurement report reports the quality of each cell PCI. The RAN node may assign a temporary cell index to the cell PCI as shown in TABLE 1 (see FIG. 10). In Step 10 of FIG. 9, when setting the configuration of candidate target cells by RRCReconfiguraiton, the RAN node may assign a temporary cell index to each candidate target cell.

Moreover, for serving cells, identification information (SSB index) of the synchronization signal block (SSB: SS (Synchronization Signal)/PBCH (Physical Broadcast Channel) Block) and CSI RS, temporary cell index and temporary SSB index/CSI RS index may be assigned as shown in TABLE 3 or TABLE 5 (see FIG. 11).

When transmitting the L1 measurement report in Step 13 of FIG. 9, the UE may report the measurement result of L1 measurement using the temporary cell index as shown in TABLE 2 (see FIG. 10).

The temporary cell index may be a number issued by the RAN node temporarily and randomly, and even if it is transmitted by L1L2 signaling (PUCCH, MAC CE), there is no security problem as described above.

When the UE reports the serving cell and SSB/CSI-RS, UE may report the measurement result of L1 measurement by using the temporary cell index and the temporary SSB index/CSI-RS index instead of the serving cell index and SSB index/CSI RS index, as in TABLE 4 or TABLE 6 (see FIG. 11).

### (3.2.2.2) Solution 2

This solution can solve Problem 2 (L1L2 mobility command security issue). In the L1L2 mobility procedure shown in FIG. 9, the RAN node determines the RAN node (source DU) serving cell change based on the measurement result of L1 measurement from the UE, and transmits an instruction to which cell to handover the UE by the L1L2 mobilitycommand (Step 13˜15 in FIG. 9).

As the cell ID included in the L1L2 mobility command, temporary cell index/temporary SSB index/CSI index may be used instead of target cell PCI. Since the UE sets the mapping relationship between temporary cell index/temporary SSB index/CSI index and PCI/servCellIndex/SSB index/CSI-RS index once in Step 10, after receiving the L1L2 mobility command, the UE may convert temporary cell index/temporary SSB index/CSI index into PCI/servCellIndex/SSB index/CSI-RS index.

Alternatively, when transmitting the L1L2 mobility command in Step 15, the RAN node may use the condReconfigId to indicate which target cell to handover the UE to.

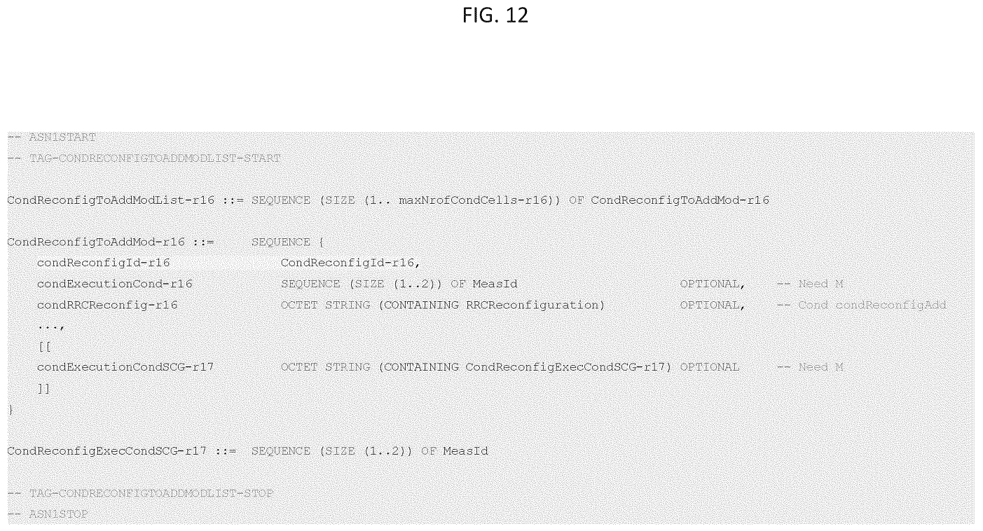

FIG. 12 shows a configuration example of the condReconfigId. The condReconfigId is specified in 3GPP TS38.331. The condReconfigId is assigned to the configuration of each candidate target cell when the RAN node sets the configuration of the candidate target cell in the UE by RRCReconfiguraiton in Step 10 of FIG. 9.

### (4) Operational Effects

According to the above embodiment, the detailed operation of the UE and network of the U-plane and C-plane when L1/L2 Mobility is applied is clarified, and L1/L2 Mobility can be realized more reliably.

In addition, in L1L2 mobility, when the quality of neighboring cell is reported by L1L2 signaling, the provisional identification information of the related cell is used, so that the possibility of identifying the handover history, movement history, and location information of the UE can be eliminated. Therefore, the risk of violating the privacy of the user can be reduced.

### (5) Other Embodiments

The contents of the present proposal have been described in accordance with the above embodiments, but it is obvious to those skilled in the art that the present proposal is not limited to these descriptions and that various modifications and improvements can be made.

### (6) Other Embodiments

The embodiments have been described above, but it is obvious to those skilled in the art that the present proposal is not limited to the descriptions of the embodiments and that various modifications and improvements can be made.

For example, in the above description, configure, activate, update, indicate, enable, specify, and select may be interchanged. Similarly, link, associate, correspond, and map may be replaced with each other, and allocate, assign, monitor, and map may be replaced with each other.

Furthermore, specific, dedicated, UE-specific, and UE-individual may be replaced with each other. Similarly, common, shared, group-common, UE-common, and UE-shared may be replaced with each other.

Note that the block diagrams (FIGS. 4 and 5) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

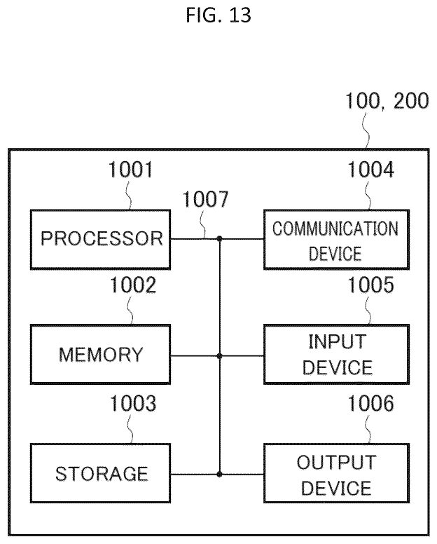

Furthermore, the gNB100 and UE200 (devices) described above may function as a computer that processes the radio communication method of this disclosure. FIG. 13 shows an example of the hardware configuration of the devices. As shown in FIG. 13, this device may be configured as a computer device including a processor 1001, a memory 1002, a storage 1003, an communication device 1004, an input device 1005, an output device 1006, and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIGS. 4 and 5) is implemented by any hardware component or combination of hardware components of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be called a register, a cache, a main memory (main memory), etc. The memory 1002 may store a program (program code), a software module, etc. capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

The devices such as the processor 1001 and the memory 1002 are connected by a bus 1007 for communicating information. The bus 1007 may be configured using a single bus or may be configured using different buses for each device.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Information notification is not limited to the aspects/embodiments described in the present disclosure, but may be performed using other methods. For example, information notification may be implemented by physical layer signaling (e.g., Downlink Control Information (DCI), Uplink Control Information (UCI), higher layer signaling (e.g., RRC signaling, Medium Access Control (MAC) signaling, notification information (Master Information Block (MIB), System Information Block (SIB)), or other signals or combinations thereof. The RRC signaling may also be referred to as an RRC message, and may be an RRC Connection Setup message, an RRC Connection Reconfiguration message, or the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc. of each aspect/embodiment described in the present disclosure may be changed in order as long as there is no contradiction. For example, the method described in the present disclosure presents the elements of the various steps using an exemplary order and is not limited to the particular order presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the aspects/embodiments described in the present disclosure may be used alone, in combination, or switched with practice. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channel and symbol may be a signal (signaling). Also, the signal may be a message. Also, a signal may be a message. Further, a component carrier (Component Carrier: CC) may be referred to as a carrier frequency, a cell, a frequency carrier, or the like. The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage. In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Similarly, the mobile station in the present disclosure may be read as a base station. In this case, the base station may have the function of the mobile station.

A radio frame may be composed of one or more frames in the time domain.

Each frame or frames in the time domain may be referred to as a subframe. A subframe may be further configured by one or more slots in the time domain.

The subframe may have a fixed time length (e.g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in time units larger than the minislot may be called PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one between a subframe and TTI may be a subframe (1 ms) in existing LTE, or may be shorter than 1 ms (for example, 1 to 13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots constituting the minimum time unit of the scheduling (the number of mini-slots) may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB based on the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to send and receive certain signals/channels outside the active BWP. Note that “cell,” “carrier,” and the like in this disclosure may be read as “3WP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” or “decision ” may include regarding some action as “judgment” or “decision”. Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.”

Terms such as “leave,” “coupled,” or the like may also be interpreted in the same manner as “different.”

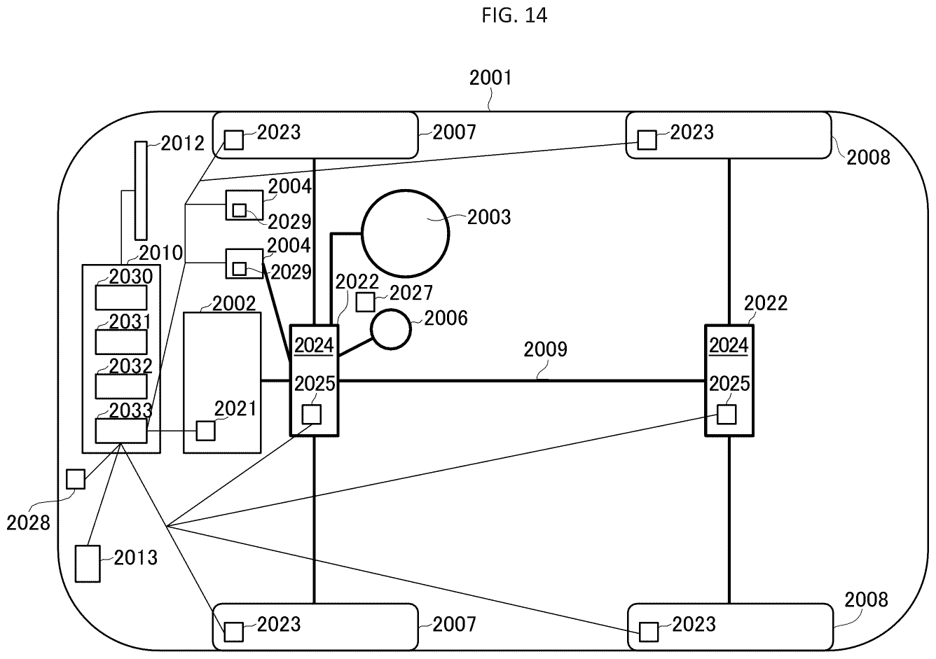

FIG. 14 shows an example of the configuration of the vehicle 2001. As shown in FIG. 14, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021˜2029, an information service unit 2012, and a communication module 2013.

The drive unit 2002 is composed of, for example, an engine, a motor, and an engine-motor hybrid.

The steering unit 2003 includes at least a steering wheel and is configured to steer at least one of the front and rear wheels based on the operation of the steering wheel operated by the user.

The electronic control unit 2010 consists of a microprocessor 2031, a memory (ROM, RAM) 2032 and communication ports (10 ports) 2033. The electronic control unit 2010 receives signals from various sensors 2021˜2027 provided in the vehicle. The electronic control unit 2010 may be referred to as an ECU (Electronic Control Unit).

The signals from the various sensors 2021-2028 include a current signal from a current sensor 2021 for sensing the current of a motor, a speed signal of a front wheel and a rear wheel acquired by an rpm sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal depressing amount signal acquired by an accelerator pedal sensor 2029, a brake pedal depressing amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 comprises various devices such as a car navigation system, an audio system, a speaker, a television, and a radio for providing various information such as driving information, traffic information, and entertainment information, and one or more ECUs for controlling these devices.

The information service unit 2012 provides various multimedia information and multimedia services to the occupants of the vehicle 2001 by utilizing information acquired from an external device via the communication module 2013 or the like.

A driver assistance system unit 2030 consists of various devices, such as millimeter-wave radar, LiDAR (Light Detection and Ranging), camera, positioning locator (e.g. GNSS), map information (e.g. high-definition (HD) maps, self-driving car (AV) maps, etc.), gyro system (e.g. IMU (Inertial Measurement Unit), INS (Inertial Navigation System), etc.), AI (Artificial Intelligence) chip, AI processor, which are used to provide functions to prevent accidents or reduce the driver's driving load, and one or more ECUs that control these devices. The driver assistance system unit 2030 also transmits and receives various information via the communication module 2013 to realize a driver assistance function or an automatic driving function.

The communication module 2013 can communicate with the microprocessor 2031 and components of the vehicle 2001 via a communication port. For example, the communication module 2013 transmits and receives data via the communication port 2033 to and from the microprocessor 2031, the memory (ROM, RAM) 2032, and the sensors 2021-2028 in the drive unit 2002, the steering unit 2003, the accelerator pedal 2004, the brake pedal 2005, the shift lever 2006, the left and right front wheels 2007, the left and right rear wheels 2008, the axle 2009, and the electronic control unit 2010 in the vehicle 2001.

The communication module 2013 is a communication device that can be controlled by the microprocessor 2031 of the electronic control unit 2010 and can communicate with external devices. For example, it transmits and receives various information to and from external devices via radio communication. The communication module 2013 may be either inside or outside the electronic control unit 2010. The external device may be, for example, a base station, a mobile station, etc.

The communication module 2013 transmits a current signal from a current sensor input to the electronic control unit 2010 to an external device via radio communication. The communication module 2013 also transmits, via radio communication, to an external device the speed signals of the front and rear wheels acquired by the rpm sensor 2022, the air pressure signals of the front and rear wheels acquired by the air pressure sensor 2023, the vehicle speed signals acquired by the vehicle speed sensor 2024, the acceleration signals acquired by the acceleration sensor 2025, the accelerator pedal depressing amount signals acquired by the accelerator pedal sensor 2029, the brake pedal depressing amount signals acquired by the brake pedal sensor 2026, the shift lever operation signals acquired by the shift lever sensor 2027, and the detection signals acquired by the object detection sensor 2028 for detecting obstacles, vehicles, pedestrians, etc., which are inputted to the electronic control unit 2010.

The communication module 2013 receives various kinds of information (traffic information, signal information, Inter-vehicular distance information, etc.) transmitted from an external device and displays them to the information service unit 2012 provided in the vehicle. The communication module 2013 also stores various information received from external devices in the memory 2032 available by the microprocessor 2031. Based on the information stored in the memory 2032, the microprocessor 2031 may the control drive unit 2002, the steering unit 2003, the accelerator pedal 2004, the brake pedal 2005, the shift lever 2006, the left and right front wheels 2007, the left and right rear wheels 2008, the axle 2009, the sensors 2021˜2028, etc. provided in the vehicle 2001.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 radio communication system
20 NG-RAN
100 gNB
110 radio communication unit
120 handover processing unit
130 measurement configuration unit
140 Control unit
200 UE
210 radio communication Unit
220 measurement reporting Unit
230 handover execution Unit
240 control unit
1001 processor
1002 memory
1003 storage
1004 communication device
1005 input device
1006 output device
1007 bus
2001 vehicle
2002 drive unit
2003 steering unit
2004 accelerator pedal
2005 brake pedal
2006 shift lever
2007 left and right front wheels
2008 left and right rear wheels
2009 axle
2010 electronic control unit
2012 information service unit
2013 communication module
2021 current sensor
2022 rpm sensor
2023 air pressure sensor
2024 speed sensor
2025 acceleration sensor
2026 brake pedal sensor
2027 shift lever sensor
2028 object detection sensor
2029 accelerator pedal sensor
2030 driver assistance system unit
2031 microprocessor
2032 memory (ROM, RAM)
2033 communication port

1. A terminal comprising:
a control unit that executes mobility control of at least one of Layer 1 and Layer 2; and
a transmission unit that transmits a layer 3 measurement report when the mobility control is applied, wherein the transmission unit transmits the measurement report including identification information of at least one of a serving cell and a neighboring cell.

2. A terminal comprising:
a control unit that executes mobility control of at least one of Layer 1 and Layer 2; and
a reception unit that receives, when the mobility control is applied, at least one of commands of the layer 1 and/or layer 2 including identification information of a provisional serving cell, a synchronization signal block or channel state information.

3. A radio communication method comprising the steps of:
executing mobility control of at least one of Layer 1 and Layer 2; and
transmitting a layer 3 measurement report when the mobility control is applied, wherein
in the transmitting step, the measurement report including identification information of at least one of a serving cell and a neighboring cell is transmitted.

4. A radio communication method comprising the steps of:
executing mobility control of at least one of Layer 1 and Layer 2; and
receiving, when the mobility control is applied, at least one of commands of the layer 1 and/or layer 2 including identification information of a provisional serving cell, a synchronization signal block or channel state information.
